(19) United States
(12) Patent Application Publication
(10) Pub. No.: US 2026/0355985 A1
(43) Pub. Date: Nov. 12, 2026

(54) Automatic Magnetic Tool Changing Apparatus and Method

(71) Applicant: Industrial Magnetics, Inc., Boyne City, MI (US)

(72) Inventor: Noah G. Skrzypczak, Kingsley, MI (US)

(73) Assignee: Industrial Magnetics, Inc., Boyne City, MI (US)

(21) Appl. No.: 19/206,770

(22) Filed: May 13, 2025

Related U.S. Application Data
(63) Continuation-in-part of application No. 19/205,379, filed on May 12, 2025.

(51) Int. Cl. B25J 15/04; B23Q 3/155

(52) U.S. Cl. CPC B25J 15/0441; B23Q 3/15553

(57) ABSTRACT

A magnetic tool changing apparatus comprising a first coupling member connectable to a manipulator and a second coupling member connectable to a tool. The first and second coupling members having permanent magnets to magnetically couple the first and second coupling members. Circumferentially spaced tabs in the first and second coupling members are radially aligned and axially spaced so that the tabs may establish a mechanically latched position, wherein the first and coupling members cannot move axially relative to one another, and a mechanically unlatched position, wherein the first and second coupling members can move axially relative to one another. A releasable locking member establishes an unlocked position, wherein the first and second coupling members may rotate relative to one another between the mechanically latched and unlatched positions, and a locked position, wherein the first and second coupling members cannot rotate relative to one another when in the mechanically latched position.

### CROSS-REFERENCE TO RELATED APPLICATIONS

This application is a continuation-in-part of U.S. patent application Ser. No. 19/205,379, titled “Automatic Magnetic Tool Changing Apparatus and Method,” filed on May 12, 2025, the entire disclosure of which is incorporated herein by reference.

### FIELD OF THE INVENTION

The present disclosure generally relates to a magnetic tool changing apparatus and method that may be used in conjunction with an automatic robotic tool changer system to releasably lock a tool to a robotic arm using magnetic coupling forces and a mechanical latch. The magnetic tool changing apparatus and method includes a first coupling member connectable to the robotic arm, and a second coupling connectable to the tool. The first coupling member and the second coupling member may be magnetically coupled to each other via a magnetic coupling force created between permanent magnets disposed within the first coupling member and the second coupling member. The magnetic coupling force properly aligns and couples the first coupling member to the second coupling member so that a mechanical latch can properly secure the first coupling member to the second coupling member. A locking member is provided to maintain the first coupling member and the second coupling member in the latched position.

### BACKGROUND

It is well known to use robotic arms and automated systems to assist in the manufacture and assembly of various workpieces and components having different sizes, weights, materials, and degrees of fragility. Typically, the end of such robotic arms and automated systems have some form of tooling, such as a gripper, suction cup, tool, etc., for engaging and manipulating the workpiece or component. To enhance the flexibility of manufacturing, it is desirable to change out or exchange the tooling at the end of the robotic arm or automated system so that the robotic arm or automated system can perform different manufacturing and assembly operations on different workpieces and components. However, manually changing the tooling on the robotic arm or automated system is a slow and inefficient process, as it requires that the robotic arm or automated system be shut down while also requiring extensive manual labor.

To resolve this problem, automatic tool changer systems have been developed to quickly exchange tooling on the end of the robotic arm or automated system without the need to manually assemble and disassemble the tooling to the robotic arm or automated system and without the need for shutting down the robotic or automated system. Such automatic tool changing systems often have problems with properly aligning and/or locking and unlocking the tooling to the robotic arm or automated system. For example, some conventional tool changers have two or more magnets that are magnetized and axisymmetric. Such tool changers have a low radial strength, and the tooling may accidentally break off from the robotic arm or automated system even with a small lateral force. Additionally, such tool changers are prone to rotation, including unintended rotation, and are not capable of controlling axial rotation. These shortcomings may cause the tooling and the working component to improperly release from the robotic arm thereby causing damage to the tooling and the working component and forcing the robotic arm our automated system to be shut down for maintenance. This can create inefficiencies that are undesirable in an industrial environment.

It would be desirable to provide an automatic magnetic tool changer that provides a quick and efficient apparatus and method for exchanging tooling for various robotic and automated systems, such as for the end of a robotic arm, that is compact, mechanically robust, has high radial strength, is resistant to unintended rotation, is adaptable to a variety of tooling, and is quick and efficient to operate.

### SUMMARY

The present disclosure provides a magnetic tool changing apparatus having a first coupling member connectable to a manipulator and having at least one first permanent magnet. The first coupling member may have a plurality of first arcuate tabs circumferentially spaced and coaxially aligned with a longitudinal axis of the first coupling member. A second coupling member is connectable to a tool and may have at least one second permanent magnet magnetically attracted to the at least one first permanent magnet of the first coupling member such that when the first coupling member is adjacently aligned to the second coupling member, the at least one first permanent magnet and the at least one second permanent magnet magnetically connect the first coupling member to the second coupling member in a magnetically coupled position. The second coupling member may have a plurality of second arcuate tabs circumferentially spaced and coaxially aligned with the longitudinal axis of the first coupling member when in the magnetically coupled position. The plurality of first arcuate tabs and the plurality of second arcuate tabs may extend along substantially equal diameters and are axially spaced along the longitudinal axis of the first coupling member to axially engage one another in the magnetically coupled position thereby defining a mechanically latched position, wherein the first coupling member is prevented from moving axially relative to the second coupling member. A releasable locking member may be slidably connected to the second coupling member and movable between a locked position, wherein the first coupling member and the second coupling member are prohibited from rotating relative to one another from the mechanically latched position, and an unlocked position, wherein the first coupling member may rotate relative to the second coupling member toward a mechanically unlatched position, wherein the first coupling member may move axially relative to the second coupling member toward a magnetically uncoupled position.

The magnetic tool changing apparatus may also provide a cam follower formed on the locking member of the second coupling member for engaging a cam slot formed in the first coupling member when in the magnetically coupled position. The cam follower may move along the cam slot between the mechanically latched position and the mechanically unlatched position upon rotation of the first coupling member relative to the second coupling member when the locking member is in the unlocked position. The cam follower cannot move along the cam slot in the mechanically latched position when the locking member is in the locked position thereby preventing rotation of the first coupling member relative to the second coupling member. The releasable locking member is biased toward the locked position by a compression spring disposed within the second coupling member.

The at least one first permanent magnet may comprise a plurality of first permanent magnets disposed in the first coupling member, and the at least one second permanent magnet may comprise a plurality of second permanent magnets disposed in the second coupling member, wherein the plurality of first and second permanent magnets have different polarities so that the first coupling member and the second coupling member are only magnetically attracted to one another when properly aligned in the magnetically coupled position.

A snap ring may be disposed in the first coupling member and may have the plurality of first arcuate tabs formed thereon, wherein the snap ring is radially flexible to allow for the plurality of second arcuate tabs on the second coupling member to axially engage and snap over the plurality of first arcuate tabs in the magnetically coupled position thereby establishing the mechanically latched position. The snap ring may further have a handle extending radially outward and received by a slot formed in the first coupling member to prohibit the rotation of the snap ring relative to the first coupling member.

The first coupling member and the second coupling member may have a fluid passageway extending therethrough, and the fluid passageway having an inlet formed in the first coupling member adaptable to communicate with a pressurized fluid source and an outlet formed in the second coupling member adaptable to communicate with the tool.

The second coupling member may be engageable with a tooling rack for holding and storing the second coupling member, wherein the releasable locking member is forced radially inward in the unlocked position when the second coupling member engages the tooling rack.

The cam slot may be arcuate and extend through a locking plate in the first coupling member wherein the arcuate cam slot has a radius extending from the longitudinal axis of the first coupling member. The cam slot may have a first end defining the unlocked position when the cam follower is positioned in the first end of the cam slot and a second end defining the locked position when the cam follower is positioned in the second end of the cam slot.

An integral first lip may extend circumferentially around and outward from an engaging surface of the first coupling member, and the first lip may have an outer tapered surface. An integral second lip may extend circumferentially around and outward from an engaging surface of the second coupling member, and the second lip may have an inner tapered surface. The outer tapered surface of the first lip and the inner tapered surface of the second lip complementarily engage one another to assist in properly aligning the first coupling member to the second coupling member in the magnetically coupled position. A block tab may extend radially outward from the first lip of the first coupling member. The second lip may have a radial void in the second coupling member, wherein the block tab on the first coupling member is received within the radial void of the second lip of the second coupling member such that the block tab limits the rotational movement of the first coupling member relative to the second coupling member by having the block tab abut the circumferential ends of the second lip of the second coupling member when rotating the first coupling member relative to the second coupling member between the mechanically unlatched position and the mechanically latched position

The present disclosure also provides for a magnetic tool changing method, wherein the steps comprise providing a first coupling member connectable to a manipulator and having at least one first permanent magnet disposed therein, and a second coupling member connectable to a tool and having at least one second permanent magnet disposed therein. The method further includes magnetically connecting the first coupling member to the second coupling member by closely aligning the first coupling member to the second coupling member so that the at least one first permanent magnet is magnetically attracted to the at least one second permanent magnet in a magnetically coupled position. The method also includes engaging a plurality of circumferentially spaced first tabs in the first coupling member with a plurality of circumferentially spaced second tabs in the second coupling member wherein the plurality of first tabs are axially spaced from and coaxially aligned with the plurality of second tabs, such that the plurality of first tabs and the plurality of second tabs do not engage one another when in the mechanically unlatched position, and the plurality of first tabs and the plurality of second tabs axially engage one another in the mechanically latched position thereby prohibiting axial movement of the first coupling member relative to the second coupling member. The steps further comprise rotating the first coupling member relative to the second coupling member between the mechanically unlatched position, wherein the first coupling member is mechanically unlatched from the second coupling member, and a mechanically latched position, wherein the first coupling member is mechanically latched to the second coupling member. The method also includes moving a releasable locking member between an unlocked position, wherein the locking member is moved radially inward to allow a cam follower to move within a first end of a cam slot between the mechanically latched position and the mechanically unlatched position, and a locked position, wherein the locking member moves radially outward to engage a second end of the cam slot thereby prohibiting movement of the cam follower along the first end of the cam slot and prohibiting rotational movement of the first coupling member relative to the second coupling member when in the locked position.

The method further includes aligning the first coupling member with the second coupling member in the magnetically coupled position by complementarily engaging an inwardly tapered first lip on the first coupling member with an outwardly tapered second lip on the second coupling member. The steps also include limiting the rotational movement of the first coupling member relative to the second coupling member by having a radially extending block tab formed on the first coupling member engage a circumferential void in the second lip on the second coupling member to abut the circumferential ends of the second lip on the second coupling member when rotating the first coupling member relative to the second coupling member between the mechanically latched position and the mechanically unlatched position.

The steps of the method may also include providing a fluid passageway extending through the first coupling member and the second coupling member.

The method of the present disclosure may also include providing a plurality of first permanent magnets in the first coupling member and a plurality of second permanent magnets in the second coupling member, wherein different polarities are provided in the plurality of first permanent magnets and in the plurality of second permanent magnets to ensure that the first coupling member and the second coupling member are only magnetically attracted when properly aligned in the magnetically coupled position.

The steps of the method may further comprise storing the second coupling member in the unlocked position by having the second coupling member engageable with a tooling rack for holding and storing the second coupling member and moving the locking member radially inward to the unlocked position.

### BRIEF DESCRIPTION OF THE DRAWINGS

The present disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a perspective view of an automatic magnetic tool changing apparatus of the of the present disclosure in a magnetically coupled position and a mechanically unlatched position;

FIG. 2 is a perspective view of the automatic magnetic tool changing apparatus of the present disclosure in a magnetically uncoupled position;

FIG. 3 is an exploded view of the automatic magnetic tool changing apparatus of the present disclosure;

FIG. 4 is a partial sectional view of the automatic magnetic tool changing apparatus of the present disclosure in a mechanically latched position and a locked position;

FIG. 5 is a partial sectional view of the automatic magnetic tool changing apparatus of the present disclosure in the mechanically unlatched position and the magnetically uncoupled position;

FIG. 6 is a partial sectional and exploded view of the automatic magnetic tool changing apparatus of the present disclosure in the mechanically unlatched position;

FIG. 7A is a top plan view of the automatic magnetic tool changing apparatus of the present disclosure in the mechanically latched position;

FIG. 7B is a cross-sectional view taken in the direction of arrows A-A shown in FIG. 7A of the automatic magnetic tool changing apparatus of the present disclosure;

FIG. 8A is a top plan view of the automatic magnetic tool changing apparatus of the present disclosure in the mechanically unlatched position;

FIG. 8B is a cross-sectional view taken in the direction of arrows B-B shown in FIG. 8A of the automatic magnetic tool changing apparatus of the present disclosure;

FIG. 9 is a cross-sectional view showing the automatic magnetic tool changing apparatus of the present disclosure in the mechanically latched position;

FIG. 10 is a top plan view of the automatic magnetic tool changing apparatus of the present disclosure showing a cam slot in a first coupling member;

FIG. 11 is a top plan view of the automatic magnetic tool changing apparatus of the present disclosure showing a snap ring in the first coupling member; and

FIG. 12 is a perspective view of a second coupling member of the automatic magnetic tool changing apparatus of the present disclosure stored in a tool rack.

### DETAILED DESCRIPTION

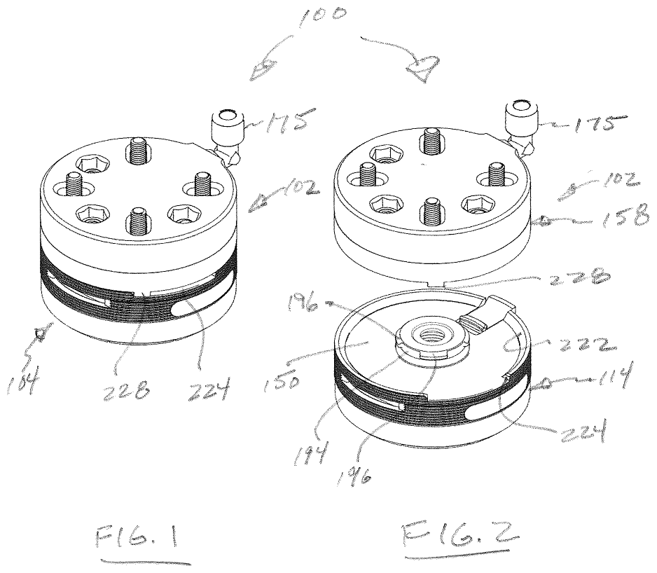

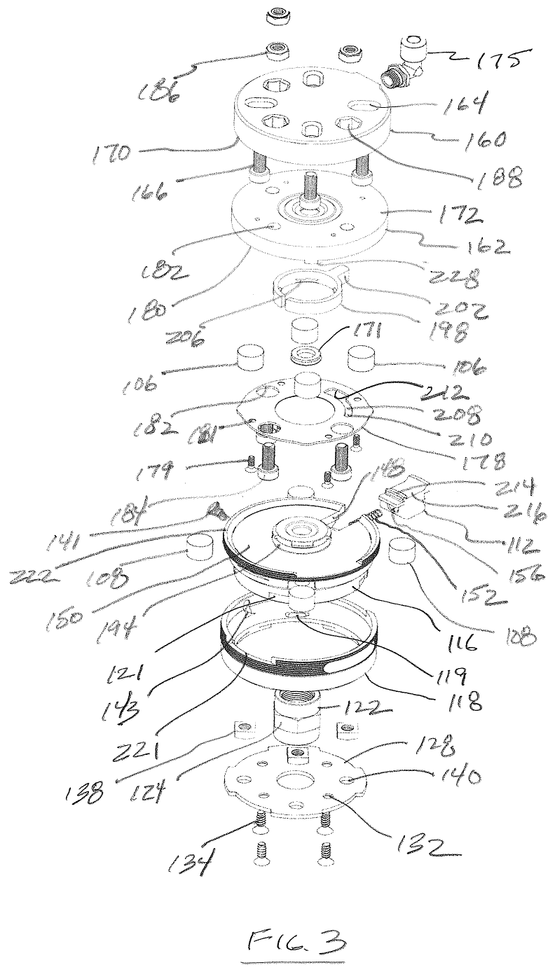

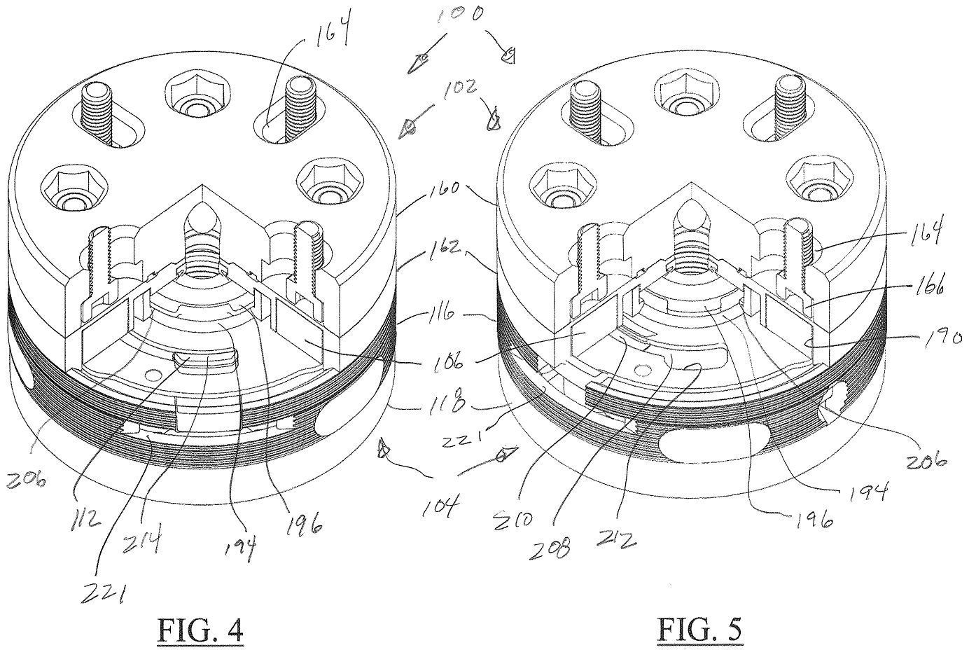

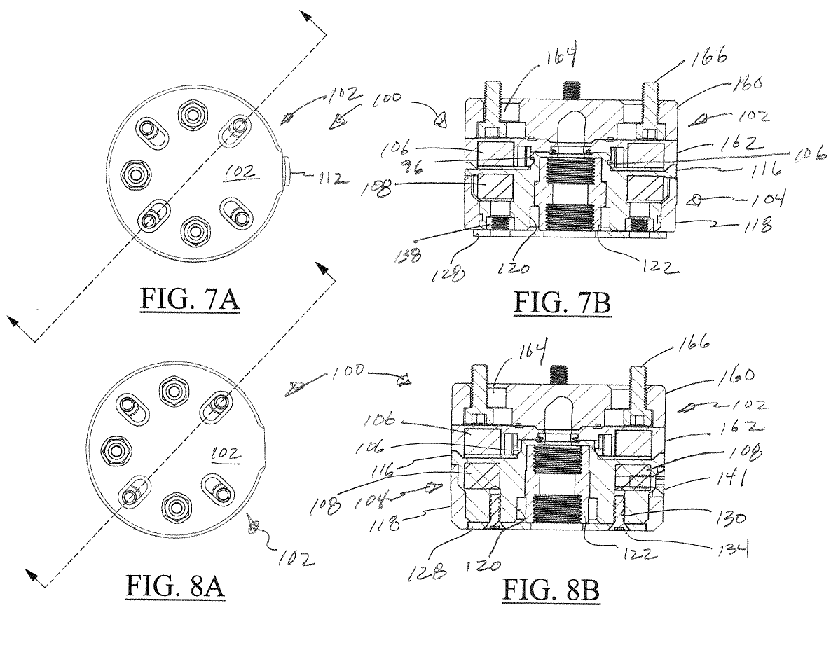

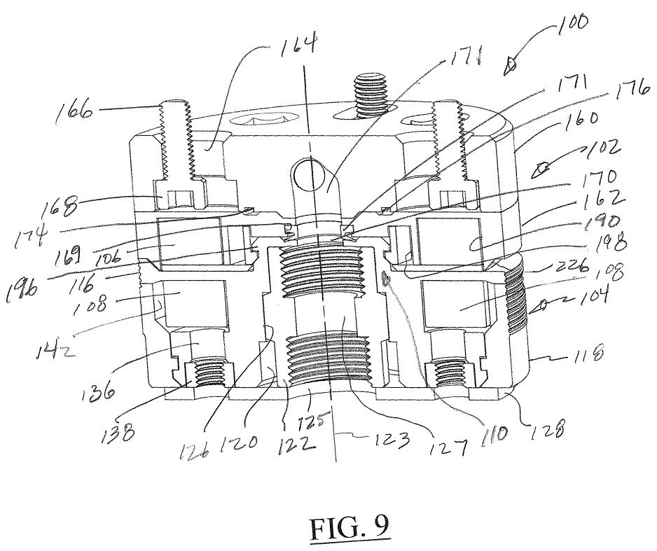

The present disclosure relates to an automatic magnetic tool changing apparatus and method 100 for releasably connecting a conventional tool or tooling (not shown) to a manipulator, conventional robotic system, such as a robotic arm (not shown), or other automated system. The present disclosure is not limited to a robotic arm, but rather, any automated system or manipulator that may utilize an automatic tool changing device may be incorporated. In a nonlimiting disclosure, a robotic arm is described as being used in connection with the automatic magnetic tool changing apparatus and method 100 of the present disclosure. The automatic magnetic tool changing apparatus and method 100 may include a first coupling member or robotic arm adapter 102 that may be connected to the robotic arm, and a second coupling member or tooling adapter 104 that may be connected to the tool or tooling. The robotic arm adapter 102 may be releasably connected to the tooling adapter 104 by using at least one permanent magnet 106 and 108 in each of the robotic arm adapter 102 and the tooling adapter 104 and a mechanical latch 110. The at least one permanent magnet 106 and 108 is disposed in each of the robotic arm adapter 102 and the tooling adapter 104, respectively, to provide a magnetic attraction between the robotic arm adapter 102 and the tooling adapter 104. When properly aligned, the robotic arm adapter 102 and the tooling adapter 104 may be magnetically connected in what is defined as the magnetically coupled position, as seen in FIG. 1. A magnetically uncoupled position is defined as the robotic arm adapter 102 and the tooling adapter 104 being separated and not magnetically connected, as seen in FIG. 2. When in the magnetically coupled position, the mechanical latch 110 may be in a mechanically latched position, which is defined as the robotic arm adapter 102 being mechanically latched to the tooling adapter 104 to prevent axial movement of the robotic arm adapter 102 relative to the tooling adapter 104, as seen in FIGS. 4, 7B, and 9, and a mechanically unlatched position, which is defined as the robotic arm adapter 102 not being mechanically latched to the tooling adapter 104 thereby allowing axial movement of the robotic arm adapter 102 relative to the tooling adapter 104, as seen in FIGS. 5 and 8B. The mechanical latch 110 provides for the releasable latching of the robotic arm adapter 102 to the tooling adapter 104 so that the tooling can be automatically exchanged on the robotic arm in an efficient and secure manner by magnetically coupling and uncoupling the robotic arm adapter 102 to the tooling adapter 104. A movable locking member 112 may releasably lock the robotic arm adapter 102 and the tooling adapter 104 in a locked position, which is defined as the robotic arm adapter 102 and the tooling adapter 104 being locked in the mechanically latched position thereby preventing rotational movement of the robotic arm adapter 102 relative to the tooling adapter 104, as seen in FIG. 4, and an unlocked position, which is defined as the robotic arm adapter 102 and the tooling adapter 104 being able to rotate between the mechanically latched position and the mechanically unlatched position, as seen in FIG. 5.

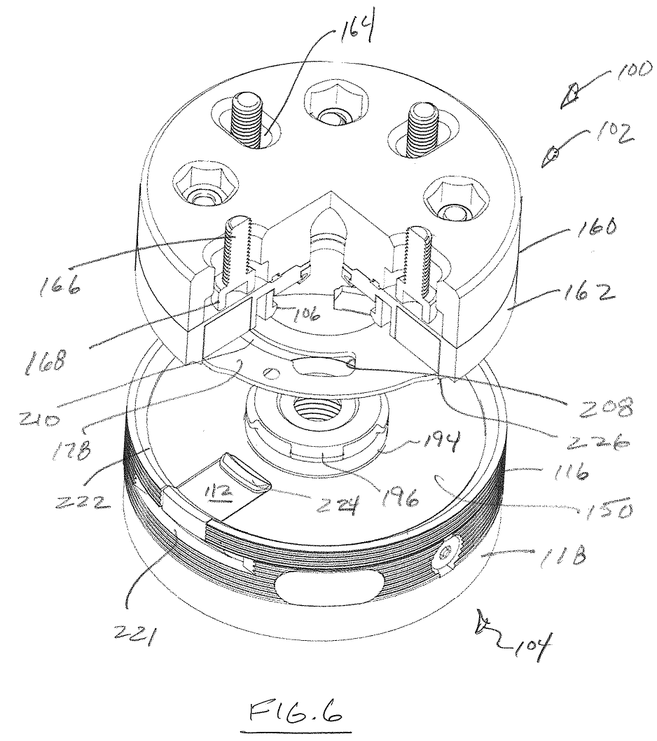

To releasably connect the tooling to the robotic arm, the tooling adapter 104 of the automatic magnetic tool changing apparatus and method 100 may be connected to the tooling. The tooling, in a nonlimiting disclosure, may comprise various types of industrial tooling (not shown), such as grippers, suction cups, machine tooling, tools, etc. As seen in FIGS. 1-9, the tooling adapter 104 may include a substantially cylindrical housing 114 having an upper substantially cylindrical portion 116 connected to a lower substantially cylindrical portion 118. As seen in FIG. 3, the lower portion 118 of the tooling adapter 104 is somewhat bowl shaped for receiving a portion of the upper portion 116 of the tooling adapter 104. A plurality of annular tabs 119 are formed on an inner surface of the lower portion 118 of the tooling adapter 104 and are received in substantially L-shaped recesses 121 formed in an outer surface of the upper portion 116 of the tooling adapter 104 to form an “insert and turn” connection. That is, the tabs 119 on the lower portion 118 of the tooling adapter 104 are inserted into and moved axially along the short leg of the L-shaped recesses 121 in the upper portion 116 of the tooling adapter 104. The upper portion 116 and the lower portion 118 of the tooling adapter 104 are then rotated relative to one another to allow the tabs 119 to travel radially along the long leg of the L-shaped recess 121 in the upper portion 116 of the tooling adapter 104.

As best seen in FIGS. 3, 7A, 7B, and 9, the upper portion 116 of the tooling adapter 104 may have a stepped bore 120 extending therethrough along a longitudinal axis 123 of the tool adapter 104. A substantially cylindrical tooling coupling 122 may be press fit or snap fit into the bore 120 of the upper portion 116 of the tooling adapter 104 by having a substantially hexagonal shaped outer midportion 124 on the tooling coupling 122 that may be received in a recess 126 in the bore 120 of the tooling adapter 104. The tooling coupling 122 may have internal threads for threadedly receiving the tooling. An aperture 127 extends through the tooling coupling 122 and is coaxially aligned with the longitudinal axis 123 of the tooling adapter 104. The aperture 127 provides a fluid passageway for directing pressurized air (positive or negative) for the operation of pneumatic or vacuum tooling or pressurized fluids for the operation of hydraulic tooling. As will be described later, the aperture 127 in the tool coupling 122 has one end that communicates with an aperture in the robotic arm adapter 102 which communicates with a pressurized air or fluid source (not shown) and a second end or outlet that communicates with the tooling. It should be noted that the present disclosure is not limited to the specific disclosure for connecting the tooling to the tooling adapter 104, as certain tooling may require different structures for connecting the tooling to the tool adapter 104.

To further support the tooling coupling 122 in the tooling adapter 104 as well as supporting the connection of the upper portion 116 to the lower portion 118 of the tooling adapter 104, a substantially cylindrical mounting plate 128 may engage and extend across the bottom of the upper portion 116, the lower portion 118, and the tooling coupling 122 of the tooling adapter 104. The mounting plate 128 may have an aperture 125 that extends therethrough and is coaxially aligned with the longitudinal axis 123 of the tooling adapter 104 and in communication with the aperture 127 in the tooling coupling 122. The mounting plate 128 may be connected to the bottom of the tooling adapter 104 by having four threaded apertures 130 formed in the bottom of the upper portion 116 of the tooling adapter 104. The mounting plate 128 may provide four apertures 132 extending therethrough which correspondingly align with the threaded apertures 130 in the bottom of the upper portion 116 of the tooling adapter 104. Four fasteners 134 may extend through the apertures 132 in the mounting plate 128 and threadedly engage the threaded apertures 130 in the upper portion 116 of the tooling adapter 104. The mounting plate 128 secures the assembly of the upper portion 116 to the lower portion 118 of the tooling adapter 104 along with supporting the tooling coupling 122 in the tooling adapter 104.

To further connect the tooling to the tooling adapter 104, four substantially equally spaced apertures 136 having counter-bores may be formed in the bottom of the upper portion 116 of the tooling adapter 104. Four threaded nuts 138 may be pressed fit into the counter-bores of the apertures 136 and/or secured in place by the mounting plate 128. The threaded nuts 138 correspondingly align with four apertures 140 that extend through the mounting plate 128. Four fasteners (not shown) connected to the tooling may extend through the apertures 140 in the mounting plate 128 and threadedly engage the threaded nuts 138 in the bottom of the upper portion 116 of the tooling adapter 104 to further secure the tooling to the tooling adapter 104. An additional fastener 141 may extend through an aperture 143 provided in a side portion of the lower portion 118 of the tooling adapter 104. The fastener 141 may thread into a threaded apertured provided in the upper portion 116 of the tooling adapter 104 for further securing the lower portion 118 to the upper portion 116 of the tooling adapter 104. As will be further described later, the fastener 141 may also be used as a sensor for the robotic arm when magnetically coupling the robotic arm adapter 102 to the tooling adapter 104.

To magnetically attract and couple the tooling adapter 104 to the robotic arm adapter 102, the housing 114 of the tooling adapter 104 includes the upper cylindrical portion 116 and the lower cylindrical portion 118. As previously described, the lower cylindrical portion 118 of the tooling adapter 104 is a substantially cylindrical hollow shell that receives a portion of the upper cylindrical portion 116 of the tooling adapter 104 such that the upper cylindrical portion 116 is partially disposed within the lower cylindrical portion 118 of the tooling adapter 104. As best seen in FIGS. 3 and 7A-9, the upper cylindrical portion 116 is somewhat solid and may provide four substantially cylindrical recess 142 that are substantially equally spaced circumferentially along a diameter that is coaxially aligned with the longitudinal axis 123 of the tooling adapter 104. The four recesses 142 house four substantially cylindrical permanent magnets 108, wherein one permanent magnet 108 is disposed in each of the four recesses 142. The recesses 142 may be open to the outer diameter of the upper portion 116 of the tooling adapter 104 so that the magnets 108 may be inserted into the recesses 142 during assembly. The lower cylindrical portion 118 of the tooling adapter 104 may cover the outer openings of the recesses 142 to hold and secure the magnets 108 in the tooling adapter 104. It should be noted that the permanent magnets 108 may vary in number, size, and magnetic strength depending on the application and size of the magnetic tool changing apparatus and method 100.

To lock the tooling adapter 104 to the robotic arm adapter 102 in the mechanically latched position, the upper cylindrical portion 116 of the tooling adapter 104 may house the spring biased locking member 112, as best seen in FIGS. 3-6. The locking member 112 may have a substantially rectangular configuration and may be slidably connected or disposed within a recess or slot 148 formed within the upper cylindrical portion 116 of the tooling adapter 104. The recess or slot 148 extends through an engaging surface or face 150 of the upper cylindrical portion 116 of the tooling adapter 104, wherein the engaging surface 150 engages an engaging surface 180 on the robotic arm adapter 102 in the magnetically coupled position, as will be described later. The locking member 112 may move linearly in a reciprocal fashion in a radial direction relative to the longitudinal axis 123 of the tooling adapter 104. The reciprocal movement of the locking member 112 is limited and defined by the length of the recess or slot 148, wherein the locking member 112 abuts the upper cylindrical portion 116 of the tooling adapter 104 when the locking member 112 moves radially inward to the fullest extent, thereby establishing the unlocked position, and abuts the lower cylindrical portion 118 of the tooling adapter 104 when the locking member 112 moves radially outward to the fullest extent, thereby establishing the locked position. A compression spring 152 has one end partially housed within an aperture (not shown) provided in the upper cylindrical portion 116 of the tooling adapter 104 and an opposite end partially housed within an aperture 156 provided in the locking member 112. The compression spring 152 biases the locking member 112 radially outward toward the locked position.

To connect the robotic arm adapter 102 to the robotic arm, the robotic arm adapter 102 includes a housing 158 having an upper substantially cylindrical portion 160 and a lower substantially cylindrical portion 162, wherein the upper portion 160 has four substantially elliptical apertures 164 extending therethrough with counterbores at the end of the apertures 164 adjacent the lower portion 162 of the robotic arm adapter 102, wherein the longitudinal axes of the apertures 164 are substantially parallel to the longitudinal axis 123 of the robotic arm adapter 102, as seen in FIGS. 3-9. One threaded fastener 166 is disposed in each of the four apertures 164, wherein the counterbore portion of each of the apertures 164 in the upper portion 160 of the robotic arm adapter 102 receives a head 168 of the fastener 166. The threaded portion of the fasteners 166 extend upward through the upper portion 160 of the robotic arm adapter 102 such that the threaded free end of the fasteners 166 extend beyond the upper portion 160 of the robotic arm adapter 102. The substantially elliptical shape of the apertures 164 allows the fasteners 166 to move radially with respect to the longitudinal axis 123 of the robotic arm adapter 102 to adjust to the position of corresponding threaded apertures (not shown) provided in a base or mounting plate (not shown) of the robotic arm. The fasteners 166 may be threaded into the apertures of a base or mounting plate of the robotic arm to secure the robotic arm adapter 102 to the robotic arm.

The robotic arm adapter 102 may also provide a portion of the fluid passageway that allows for the communication of pressured air or fluid from the pressurized air or fluid source via the robotic arm to the tooling. The lower portion 162 of the robotic arm adapter 102 may have an aperture 169 extending therethrough and coaxially aligned with the longitudinal axis 123 of the robotic arm adapter 102 and in communication with an aperture 171 extending through the upper portion 116 of the tooling adapter 104 and in communication with the aperture 127 extending through the tooling coupling 122. The aperture 169 in the lower portion 162 of the robotic arm adapter 102 may receive a rubberized gasket 171, and the aperture 169 may further extend through the upper portion 160 of the robotic arm adapter 102 wherein the aperture 169 turns substantially 90 degrees in the upper portion 160 of the robotic arm adapter 102 and continues until the aperture 169 opens into an outer surface of the upper portion 160 of the robotic arm adapter 102 to form an inlet (not shown). The inlet formed in the outer surface of the upper portion 160 of the robotic arm adapter 102 may be coupled with the pressured air or fluid source to communicate pressurized air, vacuum, or fluid to pneumatically, vacuum, or hydraulically operated tooling.

To connect the upper portion 160 to the lower portion 162 of the robotic arm adapter 102, the upper portion 160 and the lower portion 162 have opposing surfaces 170 and 172, respectively, that abut in a complementarily engaging manner. An outer radial portion of the opposing surfaces 170 and 172 of the upper portion 160 and the lower portion 162, respectively, may be substantially flat, and an inner radial portion of the opposing surfaces 170 and 172 may be contoured or stepped to provide a mated engagement of the opposing surfaces 170 and 172. An annular recess 174 may be provided in the opposing surface 170 of the upper portion 160 of the robotic arm adapter 102 for receiving a flexible seal 176. The seal 176 prevents any pressurized air or fluid from escaping from the fluid passageway in the robotic arm adapter 102 between the engaging surfaces 170 and 172 of the upper portion 160 and the lower portion 162, respectively, of the robotic arm adapter 102. The upper portion 160 and the lower portion 162 of the robotic arm adapter 102 are secured together by providing three apertures 182 that extend through the upper portion 160, the lower portion 162, and a locking plate 178, wherein the locking plate 178 is located on the engaging surface or face 180 of the lower portion 162 of the robotic arm adapter 102. The locking plate 178 is further secured to the engaging surface 180 of the lower portion 162 of the robotic arm adapter 102 through the use of four fasteners 179 that extend through four through apertures 181 in the locking plate 178 and threadedly engage four threaded apertures (not shown) provided in the lower portion 162 of the robotic arm adapter 102. As previously noted, the engaging surface 180 of the robotic arm adapter 102 engages the engaging surface 150 on the upper portion 116 of the tooling adapter 104 in the magnetically coupled position. The three apertures 182 have longitudinal axes that are substantially parallel to the longitudinal axis 123 of the robotic arm adapter 102. Three fasteners 184 extend through the apertures 182 (one fastener 184 in each aperture 182) and are threaded into substantially hexagonal threaded nuts 186 that are seated in counterbores 188 of the apertures 182 in the upper portion 160 of the robotic arm adapter 102. The counterbores 188 have a substantially hexagonal shape formed therein for receiving the hexagonal shaped threaded nuts 186 and preventing the nuts 186 from rotating. The fasteners 184 secure the lower portion 74 to the upper portion 72 of the robotic arm adapter 102.

To magnetically attract and couple the robotic arm adapter 102 to the tooling adapter 104, the lower portion 162 of the robotic arm adapter 102 may provide four substantially cylindrical apertures or recesses 190 for housing four substantially cylindrical permanent magnets 106, wherein one of the permanent magnets 106 is provided in each of the recesses 190. The recesses 190 and the permanent magnets 106 are substantially equally spaced circumferentially along a diameter that is coaxial with the longitudinal axis of the robotic arm adapter 102. The four permanent magnets 106 in the robotic arm adapter 102 correspondingly align with the four magnets 108 in the tooling adapter 104 such that when the engaging surface 180 on the lower portion 162 of the robotic arm adapter 102 closely approaches the engaging surface 150 on the upper portion 116 of the tooling adapter 104 in a properly aligned position, the permanent magnets 106 in the robotic arm adapter 102 and the magnets 108 in the tooling adapter 104 spatially oppose one another and are magnetically attracted such that the robotic arm adapter 102 and the tooling adapter 104 become magnetically connected in the magnetically coupled position, as will be further described later. In a nonlimiting disclosure, the permanent magnets 106 in the robotic arm adapter 102 may vary in number, size, and magnetic strength depending on the size and application of the automatic magnetic tool changing apparatus and method 100 of the present disclosure.

To mechanically latch the robotic arm adapter 102 to the tooling adapter 104, the upper portion 116 of the tooling adapter 104 has a substantially cylindrical center portion 194 that is coaxially aligned with the longitudinal axis 123 of the tooling adapter 104 and extends axially outward from the engaging surface 150 of the upper portion 116 of the tooling adapter 104, as seen in FIGS. 2-9. The center portion 194 may have four substantially similar tabs 196 that extend radially outward from the center portion 194 of the tooling adapter 104 and taper downward toward the engaging surface 150 of the upper portion 116 of the tooling adapter 104. The tabs 196 are substantially equally spaced about the circumference of the center portion 194, wherein the spacing between the tabs 196 is circumferentially larger than the circumferential length of the tabs 196. In a nonlimiting disclosure, the present disclosure is not limited to the size and number of the tabs 196, but rather, the size and number of tabs 196 may vary depending on the configuration of the magnetic tool changing apparatus and method 100.

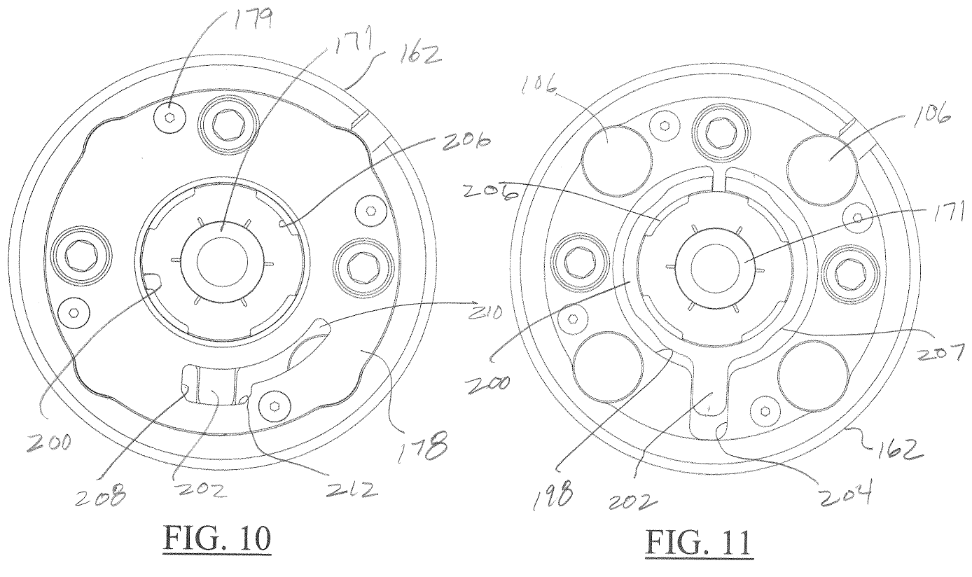

The engaging surface 180 of the lower portion 162 of the robotic arm adapter 102 has a substantially cylindrical center recess 198 that is coaxially aligned with the longitudinal axis 123 of the robotic arm adapter 102 for receiving the center portion 194 of the tooling adapter 104 when the robotic arm adapter 102 and the tooling adapter 104 are in the magnetically coupled position. The center recess 198 houses a substantially cylindrical snap ring 200, wherein a handle 202 extends integrally outward from the outer circumference of the snap ring 200 and is disposed within a slot or recess 204 provided in the lower portion 162 of the robotic arm adapter 102 to prohibit the snap ring 200 from rotating within the lower portion 162 of the robotic arm adapter 102, as seen in FIG. 11. The inner diameter of the snap ring 200 may have four similar substantially equally spaced integral tabs 206 that extend radially inward toward the center of the lower portion 162 of the robotic arm adapter 102. The tabs 206 taper downward toward the upper portion 116 of the robotic arm adapter 102 and are circumferentially spaced, wherein the spaces between the tabs 206 are circumferentially larger than the circumferential length of the tabs 206. In a nonlimiting disclosure, the tabs 206 are not limited to the size and number of tabs 206 in the present disclosure, but rather, any size and number of tabs 206 may be provided depending on the configuration of the magnetic tooling changing apparatus and method 100. The tabs 206 in the robotic arm adapter 102, and the tabs 196 on the center portion 194 of the upper portion 116 of the tooling adapter 104 are similarly sized and spaced such that when the robotic arm adapter 102 first becomes magnetically coupled to the tooling adapter 104, the tabs 206 in the robotic arm adapter 102 engage the tabs 196 on the tooling adapter 104 thereby forcing the snap ring 200 to flex radially outward thereby allowing the tabs 196 on the tooling adapter 104 to axially pass the tabs 206 on the snap ring 200. The snap ring 200 may also have four accurate recesses 207 formed on the outer circumference of the snap ring 200 and aligned with the four permanent magnets 106 in the robotic arm adapter 102 to ensure that the snap ring 200 does not engage the permanent magnets 106 when the snap ring 200 flexes radially outward. Once the tabs 196 on the tooling adapter 104 are axially spaced from the tabs 206 on the snap ring 200, the snap ring 200 contracts radially so that the tabs 196 and 206 are axially adjacent one another at substantially the same radial distance. The axial engagement of the tabs 196 and 206 prevents the robotic arm adapter 102 from moving axially relative to the tooling adapter 104 when in the mechanically latched position. As will be described later, when the robotic arm adapter 102 is rotated relative to the tooling adapter 104, the tabs 196 on the tooling adapter 104 may become aligned with the spaces between the tabs 206 on the robotic arm adapter 102 thereby allowing the tabs 196 and 206 to axially pass through the spaces between the tabs 196 and 206 without interference so that the tooling adapter 104 may move axially with respect to the robotic arm adapter 102 when in the mechanically unlatched position. When the tooling adapter 104 To lock the robotic arm adapter 102 to the tooling adapter 104 in the mechanically latched position, th [symbol] substantially cylindrical locking plate 178 is connected to the engaging surface 180 of the robot c [symbol] arm adapter 102, as previously described and best shown in FIGS. 3-6 and 10. The locking plate 17 may provide an arcuate cam slot 208 that extends through the locking plate 178 and extends radially from the longitudinal axis 123. A first end 210 of the arcuate cam slot 208 may have a substantially [symbol] onsistent width that extends throughout most of the length of the cam slot 208, and a second end 21 of the cam slot 208 may have a width that is larger than the first end 210 of the cam slot 208. The second end 212 of the cam slot 208 forms a substantially trapezoidal shape that extends radially outward from the first end 210 of the cam slot 208 from the longitudinal axis 123 of the robotic arm a [symbol] apter 102. A substantially trapezoidal shaped cam follower 214 is formed on a top surface 26 of the locking member 112 of the tooling adapter 104, wherein the cam follower 214 may be received throughout the length of the first end 210 of the cam slot 208 in the locking plate 178, thereby allowing the robotic arm adapter 102 to rotate with respect to the tooling adapter 104 in the unlocked position. When the cam follower 214 reaches the second end 212 of the cam slot 208, and the locking member 1 [symbol] 2 is allowed to move radially outward into the second end 212 of the cam slot 208 in response to the [symbol] pring bias of the spring 152, the cam follower 214 complementarily engages the trapezoidal reces [symbol] in the second end 212 of the cam slot 208. When the cam follower 214 is disposed in the trapezoida [symbol] recess of the second end 212 of the cam slot 208, the cam follower 214 is prohibited from traveling alon [symbol] the first end 210 of the cam slot 208 thereby prohibiting the robotic arm adapter 102 from rotating re [symbol] [symbol] ative to the tooling adapter 104 and prohibiting the robotic arm adapter 102 and the tooling adapter [symbol] [symbol] 04 from moving from the mechanically latched position. This is the locked position since the robo [symbol] [symbol] ic arm adapter 102 and the tooling adapter 104 cannot rotate with respect to one another to move t [symbol] [symbol] e robotic arm adapter 102 and the tooling adapter 104 to the mechanically unlatched position. If [symbol] the locking member 112 is pushed radially inward against the spring force of the spring 152, the cam [symbol] follower 214 on the locking member 112 may be allowed to travel along the entire length of the first e [symbol] [symbol] d 210 of the cam slot 208 thereby allowing the robotic arm adapter 102 to rotate with respect to the t

[symbol]

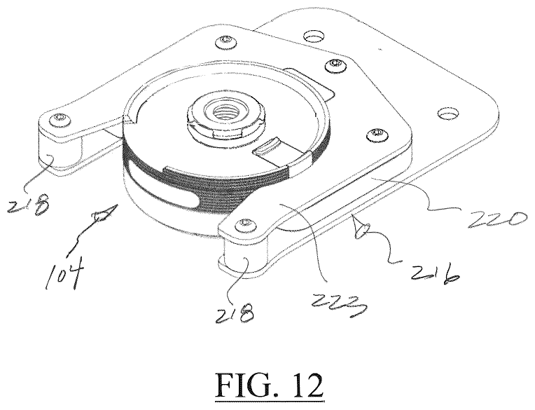

To hold and store the tooling and the tooling adapter 104 when not in use, various types of storage racks or shelves may be utilized that are accessible to the robotic arm. In a nonlimiting disclosure, the tooling may be preassembled to the tooling adapter 104 wherein the tooling adapter 104 may be held in a slotted rack 216 having a U-shaped configuration, as seen in FIG. 12. The rack 216 may have rollers 218 on the ends of the U-shaped configuration to guide the tooling adapter 104 into the rack 216, wherein the inner portion of the U-shaped configuration of the rack 216 has an arcuate configuration to complementarily receive and engage the tooling adapter 104. A rubberized or friction component 220 may be provided within the U-shaped configuration of the rack 216 to create a friction fit for holding the tooling adapter 104 in the rack 216 and preventing the tooling adapter 104 from rotating when the robotic arm rotates the robotic arm adapter 102 relative to the tooling adapter 104 when moving the robotic arm adapter 102 and the tooling adapter 104 to the mechanically unlatched position. In an alternative embodiment, the lower portion 118 of the tooling adapter 104 may have slots 221 formed therein, as seen in FIGS. 3-6, for receiving the edges of a top plate 223 of the rack 216. When the tooling adapter 104 is stored in the U-shaped configuration of the rack 216, the locking member 112 is pushed radially inward against the compression spring 152 in the unlocked position. The present disclosure if not limited to the specific configuration of the rack 216, but rather, any rack 216 configuration that will support and operate as described above is anticipated.

In operation, the automatic magnetic tool changing apparatus and method 100 of the present disclosure provides an apparatus and method by which the robotic arm may change the tooling. When the robotic arm is ready to use the tooling connected to the tooling adapter 104, the robotic arm moves the robotic arm adapter 102, which is already connected to the robotic arm, towards the tooling adapter 104 which may be positioned on the rack 216. At this point, the robotic arm adapter 102 and the tooling adapter 104 are separated in the magnetically uncoupled position. As the robotic arm moves and positions the engaging surface 180 of the robotic arm adapter 102 over the engaging surface 150 of the tooling adapter 104, the upper portion 116 of the tooling adapter 104 provides a lip 222 extending outwardly from and around the outer circumference of the engaging surface 150 of the tooling adapter 104, as best seen in FIGS. 1-3, 6 and 9. The lip 222 tapers outwardly away from the center of the tooling adapter 104 starting from the engaging surface 150 of the tooling adapter 104 to a free end of the lip 222. A portion of the lip 222 may be removed which creates a void 224 in the lip 222 along the circumference of the tooling adapter 104. The robotic arm adapter 102 also provides a lip 226 extending outwardly from and around the outer circumference of the engaging surface 180 of the robotic arm adapter 102. The lip 226 on the robotic arm adapter 102 tapers inwardly toward the center of the robotic arm adapter 102 from the engaging surface 180 of the robotic arm adapter 102 to a free end of the lip 226. The tapered surfaces on the lips 222 and 226 allows the lip 226 on the robotic arm adapter 102 to complementarily engage the lip 222 on the tooling adapter 104 and slide toward a coaxially aligned position along the longitudinal axis 123, thereby assisting in properly aligning and centering the robotic arm adapter 102 relative to the tooling adapter 104. The robotic arm adapter 102 further provides a block tab 228 integrally formed on the outer circumference of the upper portion 160 of the robotic arm adapter 102. The block tab 228 engages the void 224 where the lip 222 on the tooling adapter 104 is removed thereby limiting the rotational movement of the robotic arm adapter 102 relative to the tooling adapter 104 and providing another mechanism for ensuring the proper alignment of the robotic arm adapter 102 to the tooling adapter 104. The robotic arm may also sense the fastener 141 on the outside of the tooling adapter 104 to ensure proper alignment with the tooling adapter 104.

As the robotic arm moves the robotic arm adapter 102 into contact with the tooling adapter 104, the permanent magnets 106 and 108 in the tooling adapter 104 and the robotic arm adapter 102, respectively, are properly aligned so that the permanent magnets 106 and 108 spatially oppose one another and are drawn together magnetically thereby bringing into contact the engaging surfaces 150 and 180 of the tooling adapter 104 and the robotic arm adapter 102, respectively, in the magnetically coupled position. To ensure that the robotic arm adapter 102 and the tooling adapter 104 are properly aligned in the magnetically coupled position, one set of permanent magnets 106 and 108 in the robotic arm adapter 102 and the tooling adapter 104 may be given different polarities so that some or all the permanent magnets 106 and 108 repel one another unless the permanent magnets 106 and 108 are properly aligned. If the robotic arm adapter 102 is properly aligned with the tooling adapter 104, then the tabs 196 on the center portion 194 of the tooling adapter 104 will engage and move axially past the tabs 206 on the snap ring 200 of the robotic arm adapter 102, as the snap ring 200 flexes radially outward to allow the tabs 196 of the tooling adapter 104 to axially pass the tabs 206 on the snap ring 200 and then flexes radially inward once the tabs 196 of the tooling adapter 104 axially pass the tabs 206 on the snap ring 200 such that the tabs 196 and 206 engage each other in an axially spaced position, thereby establishing the mechanically latched position. Furthermore, the cam follower 214 on the locking member 146 engages the first end 210 of the cam slot 208 in the locking plate 178 when the tooling adapter 104 is seated in the rack 216 in the unlocked position, as previously described. At this point, the robotic arm adapter 102 and the tooling adapter 104 are in the magnetically coupled position, the mechanically latched position, and the unlocked position. However, if the tooling adapter 104 is not seated in the rack 216 such that the locking member 112 is free to move radially outward into the locked position, the robotic arm adapter 102 and the tooling adapter 104 are still free to move to the mechanically latched position upon the robotic arm adapter 102 and the tooling adapter 104 moving to the magnetically coupled position. In this instance, the robotic arm adapter 102 and the tooling adapter 104 would be in the magnetically coupled position, the mechanically latched position, and the locked position. Thus, the robotic arm adapter 102 and the tooling adapter 104 will move to the magnetically coupled position and the mechanically latched position in either the unlocked position or the locked position.

As previously noted, the robotic arm adapter 102 and the tooling adapter 104 are in the unlocked position when seated in the rack 216, as the rack 216 forces the locking member 112 radially inward to the unlocked position. To mechanically lock the robotic arm adapter 102 to the tooling adapter 104, the robotic arm removes the tooling adapter 104 from the rack 216, as the tooling adapter 104 and the robotic arm adapter 102 are in the magnetically coupled position and the mechanically latched position. Upon removing the tooling adapter 104 from the rack 216, the compression spring 152 moves the locking member 112 radially outward such that the cam follower 214 engages the second end 212 of the cam slot 208. This establishes the locked position as the robotic arm adapter 102 is prohibited from rotating relative to the tooling adapter 104. The tooling is now ready for use on the workpiece component.

To change the tooling, the robotic arm moves the tooling adapter 104 back into the tooling rack 216, as previously described. When the tooling adapter 104 is seated in the tooling rack 216, the locking member 112 is forced radially inward thereby moving the cam follower 214 into the first end 210 of the cam slot 208 and establishing the unlocked position. The robotic arm may then rotate the robotic arm adapter 102 relative to the tooling adapter 104 which allows the cam follower 214 to travel along the first end 210 of the cam slot 208 while also rotating the tabs 206 on the snap ring 200 of the robotic arm adapter 102 relative to the tabs 196 on the center portion 194 of the tooling adapter 104. When the cam follower 214 reaches the end of the first end 210 of the cam slot 208 and/or the block tab 228 on the robotic arm adapter 102 reaches the end of the void 224 to engage the end of the lip 22 on the tooling adapter 104, the tabs 206 on the snap ring 200 of the robotic arm adapter 102 will no longer be circumferentially aligned with the tabs 196 on the center portion 194 of the tooling adapter 104, and thus, the robotic arm adapter 102 may move axially relative to the tooling adapter 104 with interference from the tabs 196 and 206. This establishes the mechanically unlatched position. The robotic arm may then move the robotic arm adapter 102 axially away from the tooling adapter 104 as the rack 216 holds the tooling adapter 104 in place thereby allowing the robotic arm adapter 102 to move from the tooling adapter 104 to establish the magnetically uncoupled position. The robotic arm may then move the robotic arm adapter 102 to a different tooling adapter 104 to utilize different tooling. The same process as previously described may be used to engage the different tooling adapter 104.

While the disclosure has been made in connection with what is presently considered to be the most practical and preferred embodiment, it should be understood that the disclosure is intended to cover various modifications and equivalent arrangements described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

What is claimed is:

1. A magnetic tool changing apparatus, comprising:
a first coupling member connectable to a manipulator and having at least one first permanent magnet, and the first coupling member having a plurality of first arcuate tabs circumferentially spaced and coaxially aligned with a longitudinal axis of the first coupling member;
a second coupling member connectable to a tool and having at least one second permanent magnet magnetically attracted to the at least one first permanent magnet of the first coupling member such that when the first coupling member is adjacently aligned to the second coupling member, the at least one first permanent magnet and the at least one second permanent magnet magnetically connect the first coupling member to the second coupling member in a magnetically coupled position, and the second coupling member having a plurality of second arcuate tabs circumferentially space and coaxially aligned with the longitudinal axis of the first coupling member when in the magnetically coupled position;
the plurality of first arcuate tabs and the plurality of second arcuate tabs extending along substantially equal diameters and axially spaced along the longitudinal axis of the first coupling member to axially engage one another when in the magnetically coupled position to define a mechanically latched position, wherein the first coupling member is prevented from moving axially relative to the second coupling member; and
a releasable locking member slidably connected to the second coupling member and movable between a locked position, wherein the first coupling member and the second coupling member are prohibited from moving from the mechanically latched position, and an unlocked position, wherein the first coupling member may move relative to the second coupling member toward a mechanically unlatched position, wherein the first coupling member may move axially away from the second coupling member toward a magnetically uncoupled position.

2. The magnetic tool changing apparatus stated in claim 1, further comprising:
a cam follower formed on the locking member of the second coupling member for engaging a cam slot formed in the first coupling member when in the magnetically coupled position, wherein the cam follower may move along the cam slot between the mechanically latched position and the mechanically unlatched position upon rotation of the first coupling member relative to the second coupling member when the locking member is in the unlocked position, and wherein the cam follower cannot move along the cam slot when in the mechanically latched position when the locking member is in the locked position thereby preventing the rotation of the first coupling member relative to the second coupling member.

3. The magnetic tool changing apparatus stated in claim 1, further comprising:
the releasable locking member biased toward the locked position.

4. The magnetic tool changing apparatus stated in claim 3, further comprising:
a compression spring disposed within the second coupling member for spring biasing the releasable locking member toward the locked position.

5. The magnetic tool changing apparatus, wherein the at least one first permanent magnet and the at least one second permanent magnet further comprise:
a plurality of first permanent magnets disposed in the first coupling member, and a plurality of second permanent magnets disposed in the second coupling member, wherein the plurality of first and second permanent magnets have different polarities so that the first coupling member and the second coupling member are attracted to one another when properly aligned in the magnetically coupled position.

6. The magnetic tool changing apparatus stated in claim 2, further comprising:
a snap ring disposed in the first coupling member and having the plurality of first arcuate tabs formed on the snap ring, wherein the snap ring is radially flexible to allow for the plurality of second arcuate tabs on the second coupling member to axially engage and snap over the plurality of first arcuate tabs on the snap ring in the magnetically coupled position thereby establishing the mechanically latched position.

7. The magnetic tool changing apparatus stated in claim 6, further comprising:
the snap ring having a handle extending radially outward and received by a slot formed in the first coupling member to prohibit the rotation of the snap ring relative to the first coupling member.

8. The magnetic tool changing apparatus stated in claim 1, wherein the first coupling member and the second coupling member having a fluid passageway extending therethrough, and the fluid passageway having an inlet formed in the first coupling member adaptable to communicate with a pressurized fluid source and an outlet formed in the second coupling member adaptable to communicate with the tool.

9. The magnetic tool changing apparatus stated in claim 1, further comprising:
the second coupling member engageable with a tooling rack for holding and storing the second coupling member, wherein the releasable locking member is forced radially inward in the unlocked position when the second coupling member engages the tooling rack.

10. The magnetic tool changing apparatus stated in claim 1, wherein the cam slot further comprises:
an arcuate cam slot extending through a locking plate in the first coupling member and extending radially from the longitudinal axis of the first coupling member, wherein the slot has a first end defining the unlocked position when the cam follower is positioned in the first end of the cam slot and a second end defining the locked position when the cam follower is positioned in the second end of the cam slot.

11. The magnetic tool changing apparatus stated in claim 1, further comprising:
an integral first lip extending circumferentially around and outward from an engaging surface of the first coupling member, and the first lip having an outer tapered surface;
an integral second lip extending circumferentially around and outward from an engaging surface of the second coupling member, and the second lip having an inner tapered surface; and
the outer tapered surface of the first lip and the inner tapered surface of the second lip complementarily engaging one another to assist in properly aligning the first coupling member to the second coupling member in the magnetically coupled position.

12. The magnetic tool changing apparatus stated in claim 11, further comprising:
a block tab extending radially outward from the first lip of the first coupling member; and
the second lip having a radial void in the second coupling member, wherein the block tab on the first coupling member is received within the radial void of the second lip of the second coupling member such that the block tab limits rotational movement of the first coupling member relative to the second coupling member by having the block tab abut circumferential ends of the second lip of the second coupling member when rotating the first coupling member relative to the second coupling member between the mechanically unlatched position and the mechanically latched position.

13. A magnetic tool changing method, comprising the steps of:
providing a first coupling member connectable to a manipulator and having at least one first permanent magnet disposed therein;
providing a second coupling member connectable to a tool and having at least one second permanent magnet disposed therein;
magnetically connecting the first coupling member to the second coupling member by closely aligning the first coupling member to the second coupling member so that the at least one first permanent magnet is magnetically attracted to the at least one second permanent magnet in a magnetically coupled position; and
engaging a plurality of circumferentially spaced first tabs in the first coupling member with a plurality of circumferentially spaced second tabs in the second coupling member wherein the plurality of first tabs are axially spaced from and coaxially aligned with the plurality of second tabs, such that the plurality of first tabs and the plurality of second tabs do not engage one another when in a mechanically unlatched position, and the plurality of first tabs and the plurality of second tabs axially engage one another in a mechanically latched position thereby prohibiting axial movement of the first coupling member relative to the second coupling member.

14. The magnetic tool changing method in claim 13, the steps further comprising:
rotating the first coupling member relative to the second coupling member in an unlocked position between the mechanically unlatched position, wherein the first coupling member is mechanically unlatched from the second coupling member, and the mechanically latched position, wherein the first coupling member is mechanically latched to the second coupling member.

15. The magnetic tool changing method in claim 13, the steps further comprising:
moving a releasable locking member between an unlocked position, wherein the releasable locking member is moved radially inward to allow a cam follower to move within a first end of a cam slot between the mechanically latched position and the mechanically unlatched position, and a locked position, wherein the releasable locking member moves radially outward to engage a second end of the cam slot thereby prohibiting movement of the cam follower along the first end of the cam slot and prohibiting rotational movement of the first coupling member relative to the second coupling member.

16. The magnetic tool changing method in claim 13, the steps further comprising:
aligning the first coupling member with the second coupling member in the magnetically coupled position by complementarily engaging an inwardly tapered first lip on the first coupling member and an outwardly tapered second lip on the second coupling member.

17. The magnetic tool changing method in claim 13, the steps further comprising:
limiting rotational movement of the first coupling member relative to the second coupling member by having a radially extending block tab formed on the first coupling member engage a circumferential void in a second lip on the second coupling member to abut circumferential ends of the second lip on the second coupling member when rotating the first coupling member relative to the second coupling member between the mechanically latched position and the mechanically unlatched position.

18. The magnetic tool changing method in claim 13, the steps further comprising:
providing a fluid passageway extending through the first coupling member and the second coupling member.

19. The magnetic tool changing method in claim 13, the steps further comprising:
providing a plurality of first permanent magnets in the first coupling member and a plurality of second permanent magnets in the second coupling member, wherein different polarities are provided in the plurality of first permanent magnets and in the plurality of second permanent magnets to ensure that the first coupling member and the second coupling member are properly aligned in the magnetically coupled position.

20. The magnetic tool changing method in claim 13, the steps further comprising:
storing the second coupling member in an unlocked position by having the second coupling member engageable with a tooling rack for holding and storing the second coupling member and moving a locking member on the second coupling member radially inward to the unlocked position.
